(19) United States
(12) Patent Application Publication
(10) Pub. No.: US 2017/0087543 A1
(43) Pub. Date: Mar. 30, 2017

(54) Catalyst Activation in Fischer-Tropsch Processes

(71) Applicant: RES USA, LLC, Westminster, CO (US)

(72) Inventors: Mark D. Ibsen, Highlands Ranch, CO (US); Sergio R. Mohedas, Houston, TX (US)

(21) Appl. No.: 15/373,051

(22) Filed: Dec. 8, 2016

Related U.S. Application Data
(62) Division of application No. 12/637,686, filed on Dec. 14, 2009.
(60) Provisional application No. 61/140,502, filed on Dec. 23, 2008.

(51) Int. Cl. B01J 37/18; C10G 2/00; B01J 23/78; B01J 37/08; B01J 23/745; B01J 23/75

(52) U.S. Cl. CPC B01J 37/18; B01J 23/745; B01J 23/75; B01J 23/78; B01J 37/08; C10G 2/332; C10G 2300/703

(57) ABSTRACT

A system for activating Fischer-Tropsch catalyst comprising a reactor having a reactor outlet for overhead gas and operable under suitable conditions whereby a catalyst in a volume of liquid carrier comprising Fischer-Tropsch diesel, hydrocracking recycle oil, or a combination thereof may be activated in the presence of an activation gas; a condenser comprising an inlet fluidly connected to the reactor outlet for overhead gas and comprising a condenser outlet for condensed liquids; and a separation unit comprising an inlet fluidly connected to the condenser outlet and a separator outlet for a stream comprising primarily Fischer-Tropsch diesel; and a recycle line fluidly connecting the separator outlet, a hydrocracking unit, or both to the reactor, whereby Fischer-Tropsch diesel recovered from the reactor overhead gas, hydrocracking recycle oil, or a combination thereof may serve as liquid carrier for catalyst in the reactor. A method for activating Fischer-Tropsch catalyst is also provided.

### CROSS-REFERENCE TO RELATED APPLICATIONS

This application is a divisional application of U.S. patent application Ser. No. 12/637,686 filed on Dec. 14, 2009, which claims the benefit under 35 U.S.C. §119(e) of U.S. Provisional Patent Application No. 61/140,502 filed Dec. 23, 2008, which is hereby incorporated herein by reference in its entirety.

### STATEMENT REGARDING FEDERALLY SPONSORED ESEARCH OR DEVELOPMENT

Not Applicable.

### BACKGROUND OF THE INVENTION

Technical Field

The present invention relates generally to activation of Fischer-Tropsch catalyst. More particularly, the invention relates to activation of Fischer-Tropsch catalyst in activation gas (e.g., synthesis gas) in an economically desirable manner utilizing Fischer-Tropsch product (e.g., Fischer-Tropsch diesel) as carrier liquid.

Background of the Invention

Much research and development work has been performed to meet rising energy needs. Systems and methods for providing fuels which are more easily obtainable, less environmentally-undesirable, and cheaper are sought to overcome the current reliance on petroleum-derived fuels.

Fischer-Tropsch synthesis of hydrocarbons has been studied as a means of producing hydrocarbons from a wide variety of carbonaceous and hydrocarbon starting materials. In Fischer-Tropsch synthesis processes, coal, biomass, methane and other starting materials are gasified or reformed to produce synthesis gas, which may then be converted to hydrocarbons via Fischer-Tropsch synthesis in the presence of a suitable Fischer-Tropsch catalyst.

Suitable catalysts include cobalt and iron based catalysts which may be supported or unsupported and which may be promoted with various other metals, such as copper and potassium.

Many different activation procedures are used to activate catalysts. For example, for promoted iron Fischer-Tropsch catalysts, activation may comprise activation with carbon monoxide under activation conditions, such as temperatures of about 270° C. to 325° C. and pressures of about 0.1 atm (1.5 psi) to 9.5 atm (140 psi). High activity of the catalyst is generally correlated with the presence of iron carbides following activation. The presence of copper and potassium in the catalyst may affect activation of the catalyst. A problem with the use of carbon monoxide or carbon-monoxide-containing synthesis gas for activation is the possibility of over-carbonizing the catalyst whereby free carbon or non-carbidic carbon is produced, thus reducing the activity of the catalyst. The activity and selectivity of a Fischer-Tropsch iron catalyst may be improved if the catalyst is subjected to a hydrogen-rich synthesis gas at elevated temperature and pressure. The reaction of carbiding of the iron catalyst precursor using a hydrogen-rich synthesis gas and subsequent Fischer-Tropsch reaction both produce water. The presence of water may prevent over-carburization of the catalyst and thus improve the activity and selectivity of the catalyst.

The catalyst is typically suspended in a liquid carrier prior to activation. This carrier is conventionally a dedicated activation fluid, and acquisition thereof may involve considerable expense. Accordingly, there is a need in the industry for systems and methods for activation of Fischer-Tropsch catalyst which provide for effective and economical catalyst activation.

### SUMMARY

Herein disclosed is a method for activating a Fischer-Tropsch catalyst, the method comprising introducing catalyst, activation gas and liquid carrier comprising Fischer-Tropsch product into an activation reactor; and operating under activation conditions whereby the catalyst is activated, wherein the carrier liquid comprises Fischer-Tropsch diesel, hydro-cracking recycle oil, or a combination thereof In applications, the activation gas comprises carbon monoxide. In embodiments, the activation gas comprises synthesis gas. The synthesis gas may have a ratio of hydrogen to carbon monoxide in the range of from about 0.5 to about 1.5. The catalyst may comprise a metal selected from iron and cobalt. In instances, the catalyst further comprises at least one promoter selected from copper, potassium, and silica. In embodiments, the catalyst is combined with liquid carrier prior to being introduced into the activation reactor.

The method may further comprise removing an overhead gas from the activation reactor and condensing at least a portion of the overhead gas into condensed liquid, wherein the liquid carrier introduced into the activation reactor comprises at least a portion of the condensed liquid. The method may further comprise separating primarily non-diesel products from the condensed liquid. In applications, from at least about 1% to about 90% of the liquid carrier in the activation reactor is the condensed liquid. In applications, at least about 50%, 60%, 70%, 80%, or 90% of the liquid carrier in the activation reactor is the condensed liquid.

Also disclosed herein is a system for activating a Fischer-Tropsch catalyst, the system comprising: a reactor comprising a reactor outlet for overhead gas and operable under suitable conditions of temperature and pressure whereby a catalyst in a volume of liquid carrier comprising Fischer-Tropsch diesel, hydrocracking recycle oil, or a combination thereof may be activated in the presence of an activation gas; a condenser comprising an inlet fluidly connected to the reactor outlet for overhead gas and comprising a condenser outlet for condensed liquids; a separation unit comprising an inlet fluidly connected to the condenser outlet and a separator outlet for a stream comprising primarily Fischer-Tropsch diesel; and a recycle line fluidly connecting the separator outlet, a hydrocracking unit, or both to the reactor, whereby Fischer-Tropsch diesel recovered from the reactor overhead gas, hydrocracking recycle oil, or a combination thereof may serve as liquid carrier for catalyst in the reactor. In embodiments, the reactor comprises a full-scale Fischer-Tropsch reactor in which Fischer-Tropsch conversion is carried out following catalyst activation. In embodiments, the reactor comprises a catalyst activation reactor which is fluidly connected to a full-scale Fischer-Tropsch reactor in which Fischer-Tropsch conversion is carried out.

The system may further comprise a mixing unit comprising an inlet for liquid carrier, an inlet for catalyst to be activated, and an outlet for catalyst slurry comprising catalyst in liquid carrier, wherein the outlet of the mixing unit is fluidly connected to an inlet of the reactor. In embodiments, the system further comprises a heater positioned on the recycle line, wherein the heater is capable of heating the liquid carrier in the recycle line to a desired activation temperature prior to introduction into the reactor. The recycle line may provide at least 50%, at least 60%, at least 70%, at least 80%, or at least 90% of the liquid carrier volume in the reactor. The reactor may further comprise cooling coils. The cooling coils may be fluidly connected to a steam drum. The separator may be operable to separate a gas stream from a liquid stream comprising primarily Fischer-Tropsch diesel and a liquid stream comprising primarily non-diesel Fischer-Tropsch products.

These and other embodiments and potential advantages will be apparent in the following detailed description and drawing. Other uses of the disclosed system and method will become apparent upon reading the disclosure and viewing the accompanying drawing. While specific examples may be presented in the following description, other embodiments are also envisioned. The embodiments described herein are exemplary only, and are not intended to be limiting.

### BRIEF DESCRIPTION OF THE DRAWING

For a more detailed description of the preferred embodiment of the present invention, reference will now be made to the accompanying drawing, wherein:

FIG. 1 is a schematic of a catalyst activation system according to an embodiment of this invention.

### NOTATION AND NOMENCLATURE

As used herein, the terms “syngas” and “synthesis gas” are used to refer to a gaseous stream comprising hydrogen and carbon monoxide. The “syngas” or “synthesis gas” stream may further comprise other components, for example, without limitation, the “syngas” or “synthesis gas” stream may comprise carbon dioxide, methane, etc. The “synthesis gas” or “syngas” may be directed from a location within a Fischer-Tropsch plant. For example, in embodiments, the synthesis gas is directed to a catalyst activation reactor from a carbon dioxide absorber unit or other apparatus of a Fischer-Tropsch plant.

For the purposes of this disclosure, the terms ‘liquid carrier’ and ‘activation fluid’ will be used interchangeably to refer to a medium with which catalyst is mixed prior to or during activation.

### DETAILED DESCRIPTION

Overview.

The invention is a method for activating Fischer-Tropsch catalyst with synthesis gas in a Fischer-Tropsch liquid carrier (also referred to herein as ‘activation fluid’) by introducing the catalyst, activation gas, and liquid carrier into an activation reactor. The liquid carrier may be selected from FT diesel, hydrocracking recycle oil, or other recycled condensed Fischer-Tropsch liquid product. Although the liquid carrier may comprise a recycled FT product other than diesel, such as recycle hydrocracking oil, the following description will be made with reference to liquid carrier comprising diesel. For example, overhead diesel separation unit 40 may be an overhead liquid carrier separation unit. In embodiments, the liquid carrier level is maintained in the activation reactor by condensing diesel from the overhead, and recycling recovered diesel to the activation reactor along with, as necessary, makeup diesel. In embodiments, the liquid carrier level is maintained by recycling hydrocracking oil from a hydrocracking unit to the reactor.

This invention permits the use of Fischer-Tropsch products as liquid carrier for catalyst activation and eliminates or minimizes the need to purchase dedicated activation fluid (e.g. makeup diesel). Use of a Fischer-Tropsch product for activation via recycle of recovered overhead diesel, hydro-cracking recycle oil, or other FT product, for further activation rather than purchase of dedicated activation fluid may be economically desirable.

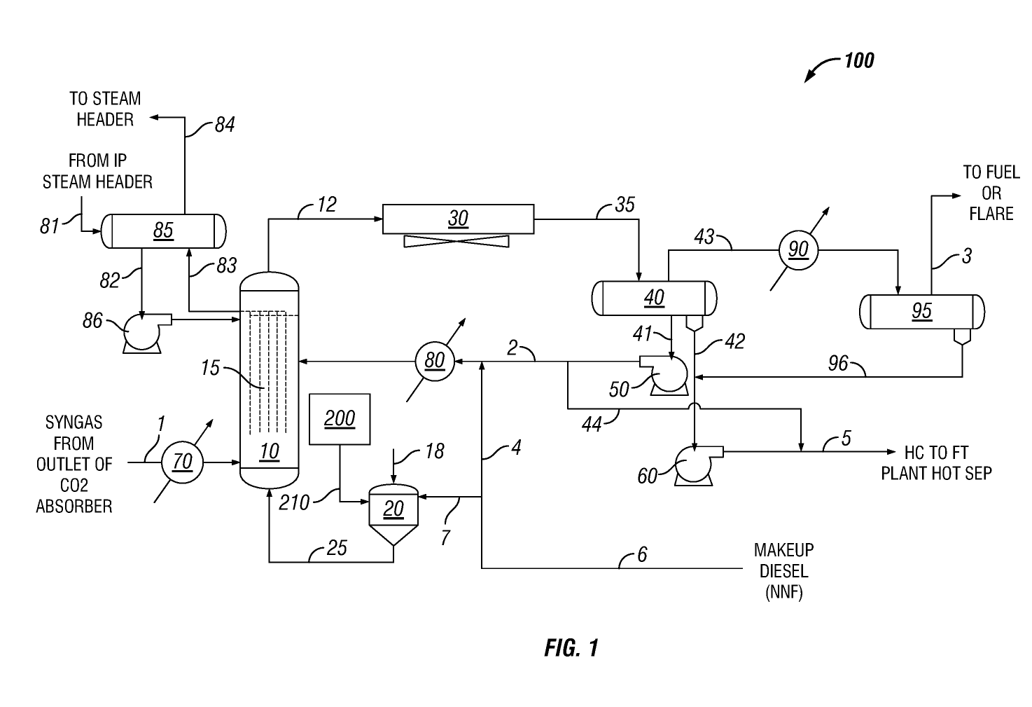

A system and process for activating Fischer-Tropsch catalyst will now be described with reference to FIG. 1, which is a schematic of a catalyst activation system 100. The disclosed system and method may permit activation of Fischer-Tropsch catalyst in a more economical manner than conventional systems and methods which may utilize a dedicated activation fluid for activating fresh or recycled catalyst.

Although descriptions of the catalyst activation system and method are made with reference to catalyst activation of Fischer-Tropsch catalyst with synthesis gas (syngas), it is understood that the disclosed system and method may be used to activate other catalysts, for example, hydrocracking catalysts. It is also understood that the disclosed system and method may comprise activation of a catalyst with a gas other than synthesis gas. For example, in embodiments, a Fischer-Tropsch catalyst may be activated with 100% carbon monoxide gas, a carbon-monoxide-rich synthesis gas or hydrogen gas.

System for Fischer-Tropsch Catalyst Activation.

Catalyst activation system 100 comprises activation reactor 10, catalyst mixing apparatus 20, and overhead diesel separation unit 40. Catalyst activation system 100 may further comprise activation steam drum 85 and activation overhead cold separation unit 95. Catalyst activation system 100 may further comprise any number of pumps for maintaining flow throughout system 100. For example, catalyst activation system 100 may comprise recycle pump 50, liquid transfer pump 60, and activation steam drum pump 86. Catalyst activation system 100 may further comprise heat transfer apparatus for maintaining the temperature throughout system 100. For example, in the embodiment of FIG. 1, catalyst activation system 100 comprises overhead condenser 30, activation reactor feed heater 70, recycle heater 80, and cooler 90. Each of these components will be described in more detail herein below. In FIG. 1, ‘NNF’ indicates ‘normally no flow’ and a catalyst hopper is not shown.

Catalyst Activation Reactor.

Catalyst activation reactor 10 is any reactor in which catalyst activation may be carried out. In embodiments, catalyst activation reactor 10 is a full-scale slurry reactor, and catalyst activation takes place in situ. In embodiments, a quantity of several thousand pounds of catalyst is pretreated in the full scale slurry reactor. In other embodiments, catalyst reactor 10 is a separate pretreatment reactor in which a smaller quantity of catalyst may be activated. For example, during operation of a Fischer-Tropsch reactor, when only a few hundred pounds of catalyst need to be pretreated to replace a portion of the inventory in a full-scale Fischer-Tropsch reactor to maintain activity, a separate pretreatment reactor 10 may be desirable. Pretreatment reactor 10 may be similar in design to a large full-scale Fischer-Tropsch reactor, but smaller in size. Once activated, a batch of activated catalyst in reactor 10 may be transferred into a full-scale Fischer-Tropsch reactor.

Catalyst Mixing Apparatus.

Catalyst activation system 100 comprises catalyst mixing apparatus 20. Catalyst mixing apparatus 20 is any unit suitable for combining catalyst to be activated with carrier liquid. Catalyst mixing apparatus 20 may be, for example, a mixing drum or a stirred tank.

Overhead Diesel Separation Unit.

Catalyst activation system 100 comprises overhead diesel separation unit 40. Although referred to as a “diesel separation unit,” it is to be understood that separation unit 40 may be a “liquid carrier separation unit,” adapted for separation of liquid carrier from other condensed liquids. Overhead diesel separation unit 40 is any unit suitable for the separation of diesel from other condensed liquids (e.g., water) in line 35. Overhead diesel separation unit 40 may separate liquids in line 35 into two or more streams. In the embodiment of FIG. 1, overhead diesel separation unit 40 separates lighter hydrocarbons and water, which exit overhead diesel separation unit 40 via line 43, from diesel, which exits overhead diesel separation unit 40 via line 41, and heavier hydrocarbons, which exit overhead diesel separation unit 40 via line 42.

Activation Steam Drum.

The Fischer-Tropsch reaction is exothermic and generates considerable heat. Reactor 10 may comprise slurry which is agitated due to introduction of gaseous reactants to the bottom of the reactor 10 and resultant mixing of the slurry. The liquid which may comprise about 80% of the slurry is thus mixed and agitated with the gas. It may be desirable to maintain the temperature within reactor 10 as constant as possible to enhance catalyst life and product production. Therefore, internal heat transfer structure 15 may be positioned within reactor 10. In embodiments, therefore, catalyst activation reactor 10 comprises internal heat transfer structure 15. Heat transfer structure 15 may comprise, for example, heating/cooling coils or heat transfer tubes.

Heat transfer structure 15 may be fluidly connected to steam drum 85. In some embodiments, a plurality of steam drums 85 are in fluid communication with a plurality of heat transfer structures (e.g. heating/cooling coils 15) within reactor 10. The one or more steam drum 85 and associated heat transfer structure 15 may be used to preheat the catalyst activation reactor to operating temperature and/or maintain a certain desire temperature or temperature profile within activation reactor 10. For example, the temperature within reactor 10 may be maintained as closely as possible to isothermal, to maximize reactor efficiency.

Some source of heat removal fluid, for example boiler feedwater, BFW 81 in FIG. 1, in a saturated state (saturated at a certain temperature and pressure) may be pumped from activation steam drum 85 via pump(s) 86 and line 82 into the heat transfer structure 15 within reactor 10.

Because of the heat released during reaction and the mixing of the reactor contents, heat transfer occurs through the walls of the cooling coils 15 and heats up the cooling fluid (e.g. saturated water) introduced via line 82. If the water is saturated, steam may be generated and removed from reactor 10 via line 83. Steam in line 84 may be sent elsewhere, for example a steam header, for subsequent use. For example, steam generated at a certain pressure may be used for power generation or to drive compressors and motors, i.e. for the power grid in the plant or can be used for other process uses such as fluid heating or injection into a chemical process. In embodiments, boiler feedwater in line 82 is saturated and boils at nearly the same temperature throughout the heat transfer structure 15. The temperature may not change appreciably. The pressure set at the steam drum 85 may be used to determine the temperature of the heat removal fluid. This temperature inside the heat transfer structure 15 determines the cooling duty provided, i.e. the amount of heat that you remove from the slurry inside reactor 10.

Specific sections of heat transfer structure (e.g., heating/cooling tubes) 15, inside reactor 10, may comprise enhanced tubes for increased heat transfer in areas where additional heat transfer is desirable. In some cases, the heat removal fluid in line 82 is not saturated water, but some other type of non vaporizing fluid. The circulation rate may be increased to adjust the heat removal rate.

Conversely, if the fluid used in steam drum 85 is superheated, saturated steam or another heat transfer fluid, it can heat the reactor 10 to the appropriate activation temperature. The stream drum 85 pressure is used, along with the steam flow to control the heating rate whereas with a heating fluid, the heating rate is controlled with the circulation of the heating fluid.

Activation Overhead Cold Separation Unit.

Catalyst activation system 100 may further comprise activation overhead cold separation unit 95. Activation overhead cold separation unit may be positioned downstream of activation diesel separation unit 40 and CW cooler 90. Cold separation unit 95 may be any unit suitable for separating heavier hydrocarbons from lighter hydrocarbons. Lighter hydrocarbons in line 3 may be sent to fuel or flare. Heavier hydrocarbons in line 96 removed from activation overhead cold separation unit 95 may be introduced into line 42 comprising non-diesel (or non-liquid carrier) liquid hydrocarbons removed in activation overhead diesel separation unit 40.

Hydrocracking Unit.

Catalyst activation system 100 may further comprise activation overhead cold separation unit 200. The hydrocracking unit 200 may be any known hydrocracking vessel operable to crack hydrocarbons into smaller molecules. A recycle hydrocracker oil line 210 may fluidly connect hydrocracking unit 200 with activation reactor 10, for example, via catalyst mixing apparatus 20, whereby recycle hydrocracking oil may be utilized as carrier liquid.

Pumps.

Catalyst activation system 100 may comprise any number of pumps for maintaining flow throughout system 100. For example, catalyst activation system 100 may comprise recycle pump 50, liquid transfer pump 60, and activation steam drum pump 86. Recycle pump 50 may fluidly connect activation reactor 10 to an outlet of activation overhead diesel separation unit 40, and may serve to recycle diesel separated from line 35 back to reactor 10. Alternatively or additionally, a recycle pump 50 may be connected with a hydrocracking unit whereby recycle hydrocracking oil may be recycled to reactor 10.

Liquid transfer pump 60 may be fluidly connected to activation overhead diesel separation unit 40 via line 42 and may serve to pump liquids from activation overhead diesel separation unit 40 and lines 42 (comprising hydrocarbons) and/or 44 (comprising diesel) to another location within the plant. For example, liquid transfer pump 60 may serve to introduce hydrocarbons to Fischer-Tropsch Plant hot separation processing units (said hot separation processing units not shown in FIG. 1) via line 5. Activation steam drum pump 86 may serve to pump heat transfer fluid in line 82 into catalyst activation reactor 10. Recycle pump 50, liquid transfer pump 60, and steam drum pump 86 may be any suitable pumps known to those of skill in the art.

Heat Transfer Apparatus.

In addition to internal heat transfer structure 15 within reactor 10, catalyst activation system 100 may further comprise other heat transfer apparatus for maintaining the temperature throughout system 100. For example, in the embodiment of FIG. 1, catalyst activation system 100 comprises overhead condenser 30, activation reactor feed heater 70, recycle heater 80, and cooler 90. Activation feed heater 70 is positioned on line 1 and is any heater suitable for adjusting the temperature of the activation gas in line 1. Activation overhead condenser 30 is positioned between catalyst activation reactor 10 and activation overhead diesel separation unit 40. Activation overhead condenser 30 may be any condenser suitable for condensing gaseous product in reactor overhead line 12 into liquids which exit overhead condenser 30 via line 35. Recycle heater 80 is positioned between activation overhead diesel separation unit 40 and catalyst activation reactor 10 and may be any heater suitable for heating the carrier fluid recycled to reactor 10. The fluid recycled to reactor 10 may comprise a portion of the diesel in line 2 recycled to reactor 10, makeup diesel in line 4, or a combination thereof In the embodiment of FIG. 1, cooler 90 is positioned between activation overhead diesel separation unit 40 and activation overhead cold separation unit 95 and may be any separation unit suitable for cooling the overhead removed from activation overhead diesel separation unit 40 via line 43 prior to introduction into activation overhead cold separation unit 95. Activation overhead condenser 30, activation reactor feed heater 70, recycle heater 80, and cooler 90 may be any suitable heaters, coolers, and condensers known to those of skill in the art.

Process for Catalyst Activation.

Description of a process for activating catalyst utilizing liquid condensate will now be made with reference to FIG. 1. Activation gas is introduced into catalyst activation reactor 10 via line 1. The activation gas may be heated to a desired temperature by activation feed heater 70. In embodiments, the activation gas comprises carbon monoxide. In embodiments, the activation gas comprises synthesis gas. In embodiments, the ratio of hydrogen to carbon monoxide in the activation gas is in the range of from about 0.5 to about 1.5. In embodiments, the ratio of hydrogen to carbon monoxide in the activation gas is in the range of from about 1.3 to about 1.5. In embodiments, the ratio of hydrogen to carbon monoxide in the activation gas is about 1.4. In embodiments, the ratio of hydrogen to carbon monoxide in the activation gas is in the range of from about 0.6 to about 0.7, or 0.67. In embodiments, the catalyst in liquid carrier (e.g., wax, diesel, oil, or a combination thereof) is first heated, for example to 275° C., in H₂ and then synthesis gas is fed for activation.

Catalyst.

Catalyst to be activated (either fresh or recycled catalyst) is introduced into catalyst mixing apparatus 20 via line 18. The catalyst may be a Fischer-Tropsch catalyst effective for catalyzing the conversion of carbon monoxide and hydrogen into C²⁺ hydrocarbons. In embodiments, the catalyst comprises cobalt. In embodiments, the catalyst comprises iron. Fischer-Tropsch catalyst that may be activated according to the disclosed system and method is described in U.S. patent application Ser. No. 12/198,459, which is hereby incorporated herein to the extent that it provides details or explanations supplemental to those disclosed herein.

In applications, the percent by weight of the disclosed iron catalyst in the reactor slurry (for example, in a slurry bubble column reactor, or SBCR) is in the range of from about 5% to about 30%. In embodiments, the percent by weight of the iron catalyst in the slurry reactor is in the range of from about 15% to about 30 percent by weight. Alternatively, the percent by weight of catalyst in the slurry phase may be in the range of from about 20% to about 30%.

Catalyst to be activated (e.g., fresh catalyst or recycled catalyst) is introduced via line 18 into catalyst mixing apparatus 20 along with liquid carrier which is introduced into mixing apparatus 20 via line 7. In embodiments, the liquid carrier comprises diesel. In embodiments, the liquid carrier comprises recycle hydrocracking oil. In embodiments, the liquid carrier comprises diesel and recycle hydrocarbon oil. In embodiments, a portion of makeup diesel in line 6 is introduced via line 7 into mixing apparatus 20. This makeup diesel may be a petroleum diesel or non-petroleum diesel (i.e., may be Fischer-Tropsch diesel or non-Fischer-Tropsch diesel). Fresh diesel may be used as the liquid makeup stream for catalyst mixing apparatus 20. In embodiments (not shown in FIG. 1), recycled Fischer-Tropsch diesel exiting activation overhead diesel separation unit 40 via line 41 may be introduced into mixing apparatus 20 for use as activation fluid in subsequent slurry formation. In certain applications liquid carrier may comprise hydro-cracking recycle oil.

Within catalyst mixing apparatus 20, catalyst to be activated is mixed with liquid carrier. Mixed catalyst slurry is introduced into catalyst activation reactor 10 via line 25.

Operating Conditions.

Within activation reactor 10, catalyst is activated in the presence of activation gas under catalyst activation conditions. In embodiments, operating conditions comprise preselected conditions of temperature and pressure. In embodiments, these pre-selected conditions of temperature encompass a temperature in the range of from about 230° C. to about 300° C. In embodiments, the pre-selected conditions of temperature encompass a temperature of from about 230° C. to about 280° C. In applications, catalyst activation occurs at about 275° C. In embodiments, pre-selected conditions of pressure encompass a pressure in the range of from about 15 psig to about 150 psig. In certain applications, catalyst activation occurs at less than about 140 psig. In specific embodiments, activation conditions comprise a temperature of about 275° C. and a pressure of about 140 psig.

In embodiments, the catalyst is activated by contacting said catalyst with a mixture of gaseous hydrogen and carbon monoxide at a temperature of from about 230° C. to 300° C., for about 0.5 to 12 hours, with a water vapor partial pressure of about 1 psia, said activation being effective to increase the activity and/or selectivity of the activated catalyst in the subsequent formation of hydrocarbons via Fischer-Tropsch reaction. In embodiments, activation in synthesis gas occurs for a time period up to 6 hours. In embodiments, the catalyst is activated by contacting said catalyst with a mixture of gaseous hydrogen and carbon monoxide at a temperature of from about 230° C. to 300° C., for about 0.5 to 5 hours.

In some embodiments, catalyst comprising support material (e.g. MgAl₂O₄, MgAl₂O₄—SiO₂, Al₂O₃, SiO₂, SiO₂—Al₂O₃, etc.) in oil or wax is first heated to 200° C. in N₂, and then synthesis gas is fed, and the temperature is ramped to a temperature in the range of about 285° C. to 300° C. In embodiments, the temperature is ramped from 200° C. to a temperature of from about 285° C. to about 300° C. at a ramp rate in the range of from 1° C./min to about 5° C./min.

During activation, a portion of the liquid carrier (for example, a portion of the diesel when the liquid carrier comprises diesel) boils off and becomes part of the vapor stream leaving reactor 10 via overhead line 12. Vapor in overhead line 12 is introduced into activation overhead condenser 30. Within activation overhead condenser 30, liquid carrier in line 12 is condensed and exits activation overhead condenser 30 in line 35. Liquid carrier may be separated from other products of line 35 within activation overhead diesel separation unit 40 and recovered via line 41.

Gas exiting activation overhead diesel separation unit 40, may be cooled via cooler 90 and introduced into activation overhead cold separation unit 95. Within activation overhead cold separation unit 95, low boiling hydrocarbons are separated from higher boiling hydrocarbons. Line 3 may be used to remove tail gas (lower boiling hydrocarbons, unconverted synthesis gas) from activation overhead cold separation unit 95. The gas in line 3 may be sent to fuel or flare. Liquid exits activation overhead cold separation unit 95 via line 96. Higher boiling liquid hydrocarbons in line 96 may be combined with hydrocarbons in line 42 from activation overhead diesel separation unit 40 and optionally a portion of line 2 via line 44 to yield line 5 comprising hydrocarbon products. The hydrocarbons in line 5 may be sent to a hot separation vessel of the Fischer-Tropsch plant via liquid transfer pump 60.

Diesel separated from activation overhead diesel separation unit 40 in line 2 may be pumped via recycle pump 50 through a recycle heater 80 and returned to catalyst activation reactor 10. Recycle heater 80 will heat the recycled diesel to a desired temperature for activation. In embodiments, a portion of the makeup diesel in line 6 is combined via line 4 with recycle diesel in line 2 prior to or subsequent recycle heater 80. In other embodiments, hydrocracking recycle oil from a hydrocracking unit is recycled to the activation reactor for use as liquid carrier. In embodiments, recycled diesel and recycle hydrocracking oil are both used as liquid carrier in the activation reactor.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, and so forth). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The disclosures of all patents, patent applications, and publications cited herein are hereby incorporated by reference, to the extent they provide exemplary, procedural or other details supplementary to those set forth herein.

1. A method for activating a Fischer-Tropsch catalyst, the method comprising:
contacting a catalyst with a gas, in the presence of a liquid carrier comprising hydrocracking recycle oil in an activation reactor, wherein the gas is a carbon monoxide-rich activation gas consisting essentially of synthesis gas having a molar ratio of hydrogen to carbon monoxide in the range of from about 0.5 to about 1.5, wherein the catalyst is a supported Fischer-Tropsch catalyst and is combined as a slurry with at least a portion of the liquid carrier prior to introduction thereof into the activation reactor;
operating the activation reactor under activation conditions whereby the catalyst is activated, wherein said activation reactor comprises a heat transfer structure fluidly connected to a steam drum configured to preheat the catalyst activation reactor to operating temperature or maintain a temperature or temperature profile within the activation reactor or control the heating rate;
removing an overhead gas from the activation reactor, condensing at least a portion of the overhead gas into a condensed liquid; and
introducing the condensed liquid into a separator, and therein separating the condensed liquid into a heavier hydrocarbon stream comprising separated non-diesel liquid hydrocarbons, a separated Fischer-Tropsch diesel stream comprising separated Fischer-Tropsch diesel, and an overhead comprising lighter hydrocarbons and water.

2. The method of claim 1 wherein the hydrocracking recycle oil constitutes at least 90% of the liquid carrier by volume.

3. The method of claim 1 wherein the hydrocracking recycle oil is from a hydrocracking unit, and wherein the method further comprises producing the recycle hydrocracking oil by hydrocracking a hydrocarbon stream.

4. The method of claim 1 further comprising obtaining the synthesis gas from a carbon dioxide absorber.

5. The method of claim 1 wherein said catalyst is fresh catalyst.

6. The method of claim 1 wherein the catalyst comprises a metal selected from iron and cobalt.

7. The method of claim 6 wherein the catalyst further comprises at least one promoter selected from copper, potassium, and silica.

8. The method of claim 1 wherein said activation conditions include ramping from a temperature of about 200° C. to a temperature in the range of from about 285° C. to about 300° C.

9. The method of claim 1 wherein the catalyst is combined with at least a portion of the liquid carrier in a mixing vessel prior to introduction thereof into the activation reactor, wherein the mixing vessel comprises
an inlet for catalyst;
one or more inlets for carrier liquids fluidly connected with a hydrocracking apparatus, whereby hydrocracking oil can be introduced into the mixing vessel, inlets fluidly connected with the separator, whereby separated Fischer-Tropsch diesel can be introduced into the mixing vessel, inlets for make-up diesel, and inlets fluidly connected to both a hydrocracking apparatus and the separator, whereby both hydrocracking oil and separated Fischer-Tropsch diesel can be introduced into the mixing vessel; and
an outlet fluidly connected with an inlet of the activation reactor, whereby catalyst slurry comprising a mixture of catalyst in carrier liquid can be introduced into the activation reactor.

10. The method of claim 1 wherein the synthesis gas has a molar ratio of hydrogen to carbon monoxide in the range of from about 1.3 to about 1.5.

11. A system for activating a Fischer-Tropsch catalyst, the system comprising:
a reactor comprising a reactor outlet for overhead gas and operable under suitable conditions of temperature and pressure whereby a catalyst in a volume of liquid carrier comprising Fischer-Tropsch diesel, hydrocracking recycle oil, or a combination thereof may be activated in the presence of an activation gas;
a condenser comprising an inlet fluidly connected to the reactor outlet for overhead gas and comprising a condenser outlet for condensed liquids;
a separation unit comprising an inlet fluidly connected to the condenser outlet and a separator outlet for a stream comprising primarily Fischer-Tropsch diesel; and
a recycle line fluidly connecting the separator outlet, a hydrocracking unit, or both to the reactor, whereby Fischer-Tropsch diesel recovered from the reactor overhead gas, hydrocracking recycle oil, or a combination thereof may serve as liquid carrier for catalyst in the reactor.

12. The system of claim 11 wherein the reactor comprises a full-scale Fischer-Tropsch reactor in which Fischer-Tropsch conversion is carried out following catalyst activation.

13. The system of claim 11 wherein the reactor comprises a catalyst activation reactor which is fluidly connected to a full-scale Fischer-Tropsch reactor in which Fischer-Tropsch conversion is carried out.

14. The system of claim 11 further comprising a mixing unit comprising an inlet for liquid carrier, an inlet for catalyst to be activated, and an outlet for catalyst slurry comprising catalyst in liquid carrier, wherein the outlet of the mixing unit is fluidly connected to an inlet of the reactor.

15. The system of claim 11 further comprising a heater positioned on the recycle line, wherein the heater is capable of heating the liquid carrier in the recycle line to a desired activation temperature prior to introduction into the reactor.

16. The system of claim 11 wherein the recycle line provides at least 50% of the liquid carrier volume in the reactor.

17. The system of claim 11 wherein the reactor further comprises cooling coils.

18. The system of claim 17 wherein the cooling coils are fluidly connected to a steam drum.

19. The system of claim 18 wherein the steam drum is configured to preheat the catalyst activation reactor to operating temperature or maintain a temperature or temperature profile within the activation reactor or control the heating rate.

20. The system of claim 11 wherein the separator is operable to separate a gas stream from a liquid stream comprising primarily Fischer-Tropsch diesel and a liquid stream comprising primarily non-diesel Fischer-Tropsch products.
